(19) United States
(12) Patent Application Publication
(10) Pub. No.: US 2014/0181527 A1
(43) Pub. Date: Jun. 26, 2014

(54) UNSECURE NETWORK SOCKET COMMUNICATION

(71) Applicant: HEWLETT-PACKARD DEVELOPMENT COMPANY, L.P., Houston, TX (US)

(72) Inventors: Ana Paula Salengue Scolari, Porto Alegre (BR); Andre Lopes, Porto Alegre (BR); Sandro Rafaeli, Porto Alegre (BR); Marcio Figueira, Porto Alegre (BR); Iuri Fiedoruk, Porto Alegre (BR)

(73) Assignee: Hewlett-Packard Development Company, L.P., Houston, TX (US)

(21) Appl. No.: 13/723,484

(22) Filed: Dec. 21, 2012

(51) Int. Cl. H04L 9/32

(52) U.S. Cl. CPC H04L 9/3281
USPC 713/176

(57) ABSTRACT

Disclosed herein are techniques for secure communications through unsecure sockets. It is determined whether an executable file contains a signature from a trustworthy source. If the executable file contains the trustworthy signature, communication from a process is permitted.

### BACKGROUND

Mechanisms for Inter Process Communication (“IPC”) are widely used in modern software architectures. Some systems use a process known as an IPC bus to route messages between applications. Secure Socket Layer (“SSL”) protocol may be used to provide secure communications between processes.

### BRIEF DESCRIPTION OF THE DRAWINGS

FIG. 1 is a block diagram of an example system in accordance with aspects of the present disclosure.

FIG. 2 is a flow diagram of an example method in accordance with aspects of the present disclosure.

FIGS. 3-3A are examples in accordance with aspects of the present disclosure.

FIGS. 4 is a further example in accordance with aspects of the present disclosure.

### DETAILED DESCRIPTION

As noted above, inter process communications are widely used in software architectures. One solution for secure inter process communication is SSL. Under SSL, information is encrypted by the sender with a private cryptographic key and decrypted by the receiver with a corresponding public key. If the received information is successfully decrypted with the public key, the receiver assumes the sender is trustworthy. Without access to the private key, a sending process may be unable to prove its authenticity.

However, a malicious process (e.g., worms, viruses, Trojans etc.) may obtain privileges similar to those of other authentic processes (e.g., when they execute under the same user account). In this instance, the malicious process may have unfettered access to privileged resources. With such privileges, the private cryptographic keys needed to deliver messages using SSL protocol may also be obtained. Thus, malicious programs with such privileges can pose as an authentic process and can mislead other programs into accepting information therefrom. The information transmitted by these programs may be information that destroys data or that allows unauthorized access to sensitive information.

In view of the foregoing, disclosed herein are a system, non-transitory computer readable medium and method for secure communications through an unsecure socket. In one example, a socket application programming interface may be used to access a plurality of data structures containing data associated with inter process communication. In another example, at least some of the plurality of data structures may be searched or analyzed to locate an executable file. Such an executable file may have instructions therein which, if executed, instruct at least one processor to execute the request to communicate or transmit data through an unsecure socket. The process is permitted to transmit data if the executable file contains a trustworthy digital signature.

The techniques disclosed herein provide protection from malicious programs that have procured privileged access to particular resources. Such programs may be able to circumvent conventional security practices. The solutions disclosed in the present disclosure employ infrastructure provided by most operating systems such that the system, non-transitory computer readable medium, and method are portable across most computing environments. The aspects, features and advantages of the present disclosure will be appreciated when considered with reference to the following description of examples and accompanying figures. The following description does not limit the application; rather, the scope of the disclosure is defined by the appended claims and equivalents.

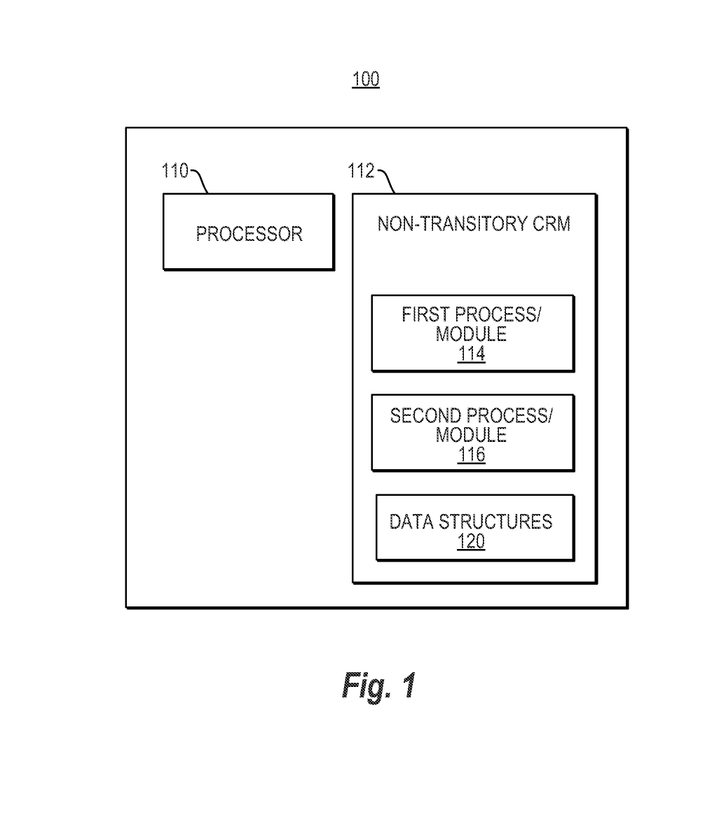

FIG. 1 presents a schematic diagram of an illustrative computer apparatus 100 for executing the techniques disclosed in the present disclosure. The computer apparatus 100 may include all the components normally used in connection with a computer. For example, it may have a keyboard and mouse and/or various other types of input devices such as pen-inputs, joysticks, buttons, touch screens, etc., as well as a display, which could include, for instance, a CRT, LCD, plasma screen monitor, TV, projector, etc. Computer apparatus 100 may also comprise a network interface (not shown) to communicate with other devices over a network.

The computer apparatus 100 may also contain a processor 110, which may be any number of well known processors, such as processors from Intel® Corporation. In another example, processor 110 may be an application specific integrated circuit (“ASIC”). Non-transitory computer readable medium (“CRM”) 112 may store instructions that may be retrieved and executed by processor 110. The instructions may include a first process 114 and a second process 116. In the example of FIG. 1, first process 114 may contain instructions which, if executed, instruct processor 110 to execute the techniques disclosed herein. Furthermore, non-transitory CRM 112 may contain data that may be retrieved by processor 110, such as data structures 120. As will be explained further below, data structures 120 may contain data associated with network socket connections.

In one example, non-transitory CRM 112 may be used by or in connection with any instruction execution system that can fetch or obtain the logic from non-transitory CRM 112, such as computer apparatus 100, and execute the instructions contained therein. Non-transitory computer readable media may comprise any one of many physical media such as, for example, electronic, magnetic, optical, electromagnetic, or semiconductor media. More specific examples of suitable non-transitory computer-readable media include, but are not limited to, a portable magnetic computer diskette such as floppy diskettes or hard drives, a read-only memory (“ROM”), an erasable programmable read-only memory, a portable compact disc or other storage devices that may be coupled to computer apparatus 100 directly or indirectly. Alternatively, non-transitory CRM 112 may be a random access memory (“RAM”) device or may be divided into multiple memory segments organized as dual in-line memory modules (“DIMMs”). The non-transitory CRM 112 may also include any combination of one or more of the foregoing and/or other devices as well. While only one processor and one non-transitory CRM are shown in FIG. 1, computer apparatus 100 may actually comprise additional processors and memories that may or may not be stored within the same physical housing or location.

The instructions residing in non-transitory CRM 112 may comprise any set of instructions to be executed directly (such as machine code) or indirectly (such as scripts) by processor 110. In this regard, the terms “modules,” “scripts,” and “processes” may be used interchangeably herein. The computer executable instructions may be stored in any computer language or format, such as in object code or modules of source code.

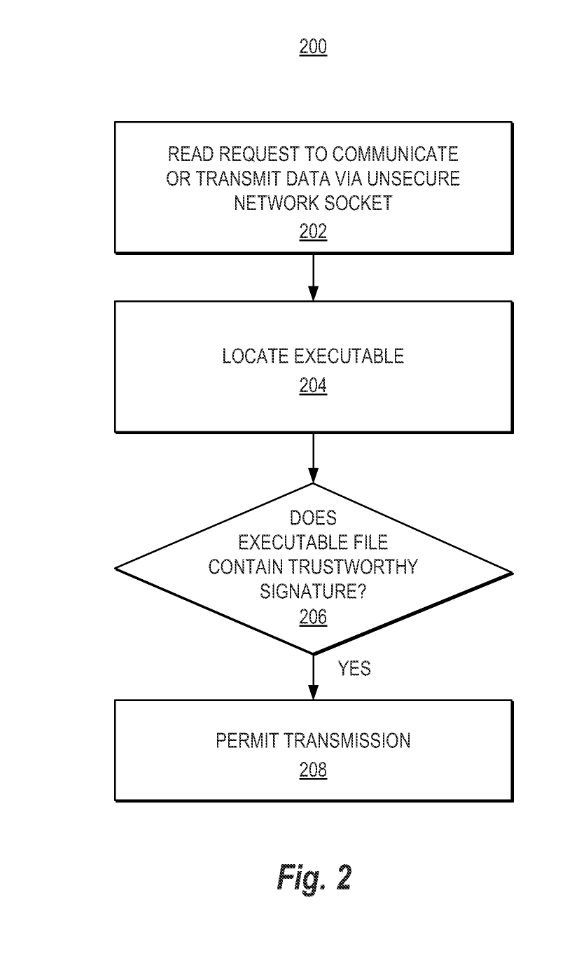

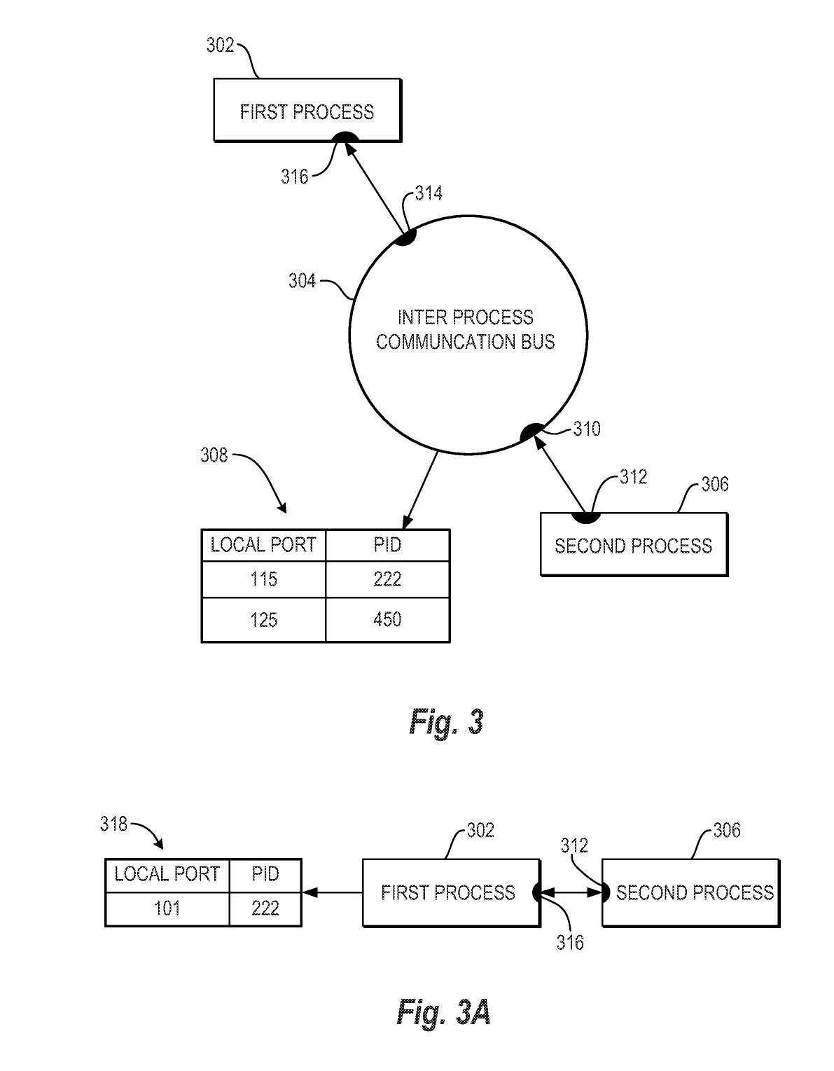

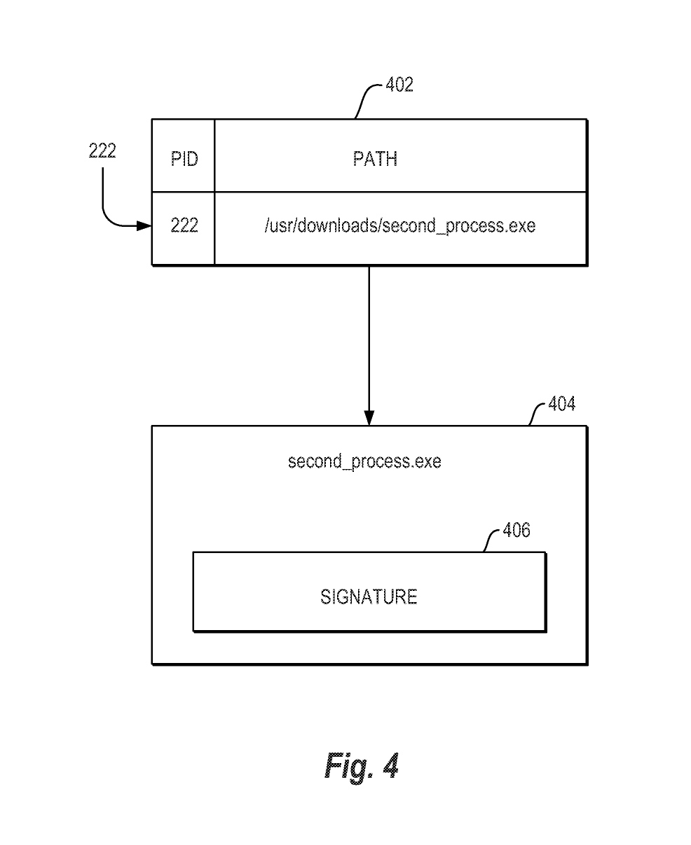

Working examples of the system, method, and non-transitory computer-readable medium are shown in FIGS. 2-4. In particular, FIG. 2 illustrates a flow diagram of an example method 200 for securing communications between processes. FIGS. 3-4 show a working example in accordance with the techniques disclosed herein. The actions shown in FIGS. 3-4 will be discussed below with regard to the flow diagram of FIG. 2.

Referring to FIG. 2, a request to communicate or transmit data via an unsecure network socket may be received, as shown in block 202. Referring now to the example of FIG. 3, second process 306 may send a request for communication with first process 302 via an unsecure network socket 310. Sockets are basic abstractions of network communication; they define an endpoint of communication for a process. Processes may communicate by sending data packets into a socket and reading data packets from a socket. In one example, an unsecure socket may be defined as a socket that is not in accordance with a security protocol. While the example in FIG. 3 shows inter process communication bus (“IPC bus”) 304 forwarding packets of data to first process 302, it is understood that the techniques herein could also be used between two processes communicating directly. For example, FIG. 3A shows second process 306 communicating directly with first process 302 using unsecure socket 316. IPC bus 304 or first process 302 may transmit messages back to second process 306 via unsecure network socket 312.

Referring back to FIG. 2, the executable file that executes the request may be located, as shown in block 204. That is, the executable file having instructions therein which execute the second process may be located. In the example of FIG. 3, IPC bus 304 may be responsible for locating the executable file. In the example of FIG. 3A, first process 302 may locate the executable file instead of IPC bus 304. In a further example, the executable file may be located using data structures associated with network socket connections. Due to the wide use of sockets today, most operating systems maintain such data as part of their TCP/IP infrastructure. Such data may be accessible via a socket application programming interface (“socket API”). An API may be a computer process or mechanism that allows an application to access certain infrastructure provided by an operating system. The socket API may be used to create, close, read and write to and from a socket. Furthermore, the socket API may allow programs to invoke socket operating system services. Such services may include obtaining information associated with processes utilizing sockets.

FIG. 3 shows an illustrative data structure 308 that may contain information associated with each active network socket connection in the system and associates each connection with a local port. As noted above, such data may be maintained by most operating systems. In the example of FIG. 3, data structure 308 is shown having information associated with two socket connections. In the example of FIG. 3, IPC bus 304 may use this table to obtain an identifier associated with second process 306. IPC bus 304 may be associated with local port 115 and second process 306 may be associated with process identifier 222. Thus, the first row of data structure 308 may represent the connection between IPC bus 304 and second process 306. In the example of FIG. 3A, data structure 318 may also contain information associated with each active network connection in the system. As with data structure 308, the information in data structure 318 may also be maintained by most operating systems. First process 302 may be associated with local port 101 and second process 306 may be associated with identifier 222; thus, the row shown in data structure 318 may represent a connection between first process 302 and second process 306.

Referring now to FIG. 4, using the identifier 222 obtained from data structure 308 or data structure 318, the location of the executable file may be determined from data structure 402. Data structure 402 may contain information associated with processes or modules executing in the system. As with the data in data structure 308 and data structure 318, the type of information in data structure 402 may also be maintained by most operating systems. Each process may be associated with an identifier. The first process 302 or IPC bus 304 may look up the location of the computer executable file in the data structure using the identifier as the key. In the example of FIG. 4, the path of second process 306, which is associated with identifier 222, is shown to be “/usr/downloads/second_process.exe.”

Referring back to FIG. 2, it is determined whether the executable file contains a trustworthy signature, as shown in block 206. Many vendors of executable files may distribute such files with vendor metadata therein. In one example, a trustworthy signature may be defined as metadata included in the executable file that verifies the integrity of the executable. Thus, the integrity of the executable file may be verified to ensure it's not posing as a trusted program. Referring again to FIG. 2, if the executable file contains the trustworthy electronic or digital signature, communication is permitted, as shown in block 208. Referring back to FIG. 4, the executable file 404 is shown containing a signature 406 that may have been generated by a trustworthy third party, such as a trustworthy vendor. Once the trustworthiness is confirmed, IPC bus 304 may allow data to be transmitted to first process 302. Alternatively, if first process 302 and second process 306 are communicating directly, first process 302 may accept data from second process 306. If the signature is not trustworthy or if no signature exists, then second process 306 may be prevented from communicating with any other process in the system. In another example, second process 306 may even be removed or quarantined.

Advantageously, the foregoing system, non-transitory computer readable medium, and method provide security against malicious programs that obtain elevated privileges. By using data maintained by most operating systems, processes can confirm the trustworthiness of other processes. In this regard users are given greater protection against malicious software. In turn, corporate or government computer systems may experience less downtime and proceed more effectively.

Although the disclosure herein has been described with reference to particular examples, it is to be understood that these examples are merely illustrative of the principles of the disclosure. It is therefore to be understood that numerous modifications may be made to the examples and that other arrangements may be devised without departing from the spirit and scope of the disclosure as defined by the appended claims. Furthermore, while particular processes are shown in a specific order in the appended drawings, such processes are not limited to any particular order unless such order is expressly set forth herein; rather, processes may be performed in a different order or concurrently and steps may be added or omitted.

1. A system comprising:
a network socket application programming interface
a plurality of data structures containing data associated with network socket connections;
a first module which, if executed, instructs at least one processor to:
read a request from a second module for communication via an unsecure network socket;
search at least some of the plurality of data structures via the programming interface to locate a computer executable file, the computer executable file containing instructions therein which, if executed, instruct at least one processor to execute the second module; and
permit communication from the second module, if it is determined that the computer executable file contains a digital signature generated by a trustworthy source.

2. The system of claim 1, wherein the plurality of data structures comprise a first data structure to contain information associated with modules executing in the system and to associate each module with an identifier.

3. The system of claim 2, wherein to locate the computer executable file, the first module, if executed, further instructs at least one processor to obtain an identifier associated with the second module and lookup a location of the computer executable file in the first data structure using the identifier.

4. The system of claim 3, wherein the plurality of data structures further comprise a second data structure to contain information associated with each active network connection in the system and to associate each network connection with a local port.

5. The system of claim 4, wherein to obtain the identifier associated with the second module, the first module, if executed, instructs at least one processor to:
use a local port associated with the first module to lookup information associated with a network connection between the first module and the second module in the second data structure; and
obtain the identifier associated with the second module from the information associated with the network connection.

6. The system of claim 1, wherein the first module is an inter process communication bus to forward packets from the second module to a third module.

7. A non-transitory computer readable medium comprising instructions stored therein which, if executed, instructs at least one processor to:
access, using a socket application programming interface, a plurality of data structures containing data associated with inter process communication;
read a request to transmit data to a first process from a second process via an unsecure network socket;
analyze at least some of the plurality of data structures to determine a location of an executable file which, if executed, instructs at least one processor to execute the second process; and
permit the second process to transmit data to the first process via the unsecure network socket, if it is determined that the executable file contains a trustworthy digital signature.

8. The non-transitory computer readable medium of claim 7, wherein the instructions stored therein, if executed, further instruct at least one processor to use an identifier associated with the second process to obtain the location of the executable file.

9. The non-transitory computer readable medium of claim 8, wherein the instructions stored therein, if executed, further instruct at least one processor to lookup the location of the executable file in a first data structure of the plurality of data structures that associates the identifier with the location of the executable file.

10. The non-transitory computer readable medium of claim 9, wherein the instructions stored therein, if executed, further instruct at least one processor to use a local port associated with the first process to obtain the identifier.

11. The non-transitory computer readable medium of claim 10, wherein the instructions stored therein, if executed, further instruct at least one processor to lookup the identifier associated with the location of the executable file in a second data structure of the plurality of data structures that associates the local port with the identifier.

12. The non-transitory computer readable medium of claim 7, wherein the first process is an inter process communication bus to forward packets from the second process to a third process.

13. A method comprising:
handling, using at least one processor, a request to transmit data packets through an unsecure network socket to a first process, the request being generated by a second process;
searching, using at least one processor, operating system data structures that contain data associated with inter-process communication to locate an executable file, the executable file containing computer readable instructions therein that instruct at least one processor to execute the second process;
determining, using at least one processor, whether the executable file contains an electronic signature generated from a trusted third party; and
if it is determined that the executable file contains the electronic signature, permitting, using at least one processor, the second process to transmit packets to the first process through the unsecure network socket.

14. The method of claim 13, wherein determining the location of the executable file comprises obtaining, using at least one processor, the location of the executable file with an identifier associated with the second process.

15. The method of claim 14, wherein determining the location of the executable file further comprises searching, using at least one processor, the location of the executable file in a first data structure of the operating system data structures that associates the identifier with the location.

16. The method of claim 15, wherein obtaining the identifier associated with the second process comprises obtaining, using at least one processor, a local port associated with the first process.

17. The method of claim 16, wherein obtaining the identifier associated with the second process comprises searching, using at least one processor, a second data structure of the operating system data structures that associates the local port with the identifier.

18. The method of claim 13, wherein the first process is an inter process communication bus to forward packets from the second process to a third process.
